(19) United States
(12) Patent Application Publication
(10) Pub. No.: US 2026/0205890 A1
(43) Pub. Date: Jul. 16, 2026

(54) A Method of Establishing a Connection between a Non-Access Point, AP, Wireless Station, STA, and an Access Point, AP, as well as Corresponding Devices

(71) Applicant: Telefonaktiebolaget LM Ericsson (publ), Stockholm (SE)

(72) Inventors: Charlie Pettersson, Solna (SE); Dennis Sundman, Sollentuna (SE); Sebastian Max, Cologne (DE)

(21) Appl. No.: 19/134,880

(22) PCT Filed: Dec. 5, 2023
(86) PCT No.: PCT/EP2023/084205

§ 371 Date: Jun. 2, 2025

Related U.S. Application Data
(60) Provisional application No. 63/431,123, filed on Dec. 8, 2022.

(51) Int. Cl. H04W 28/26; H04L 5/00; H04W 52/02; H04W 76/10; H04W 84/12

(52) U.S. Cl. CPC H04W 28/26; H04L 5/0053; H04W 52/0216; H04W 76/10; H04W 84/12

(57) ABSTRACT

A method of establishing a connection between a non-Access Point, AP, wireless station, STA, and an Access Point, AP, of a wireless Local Area Network, WLAN, wherein said method comprises the steps of providing, by said STA, to said AP, at least one parameter related to resource reservation at said AP for latency sensitive traffic, receiving, by said STA, from said AP, an indication pertaining to reservable resources at said AP for said latency sensitive traffic, requesting, by said STA, to said AP, said connection between said STA and said AP, receiving, by said STA, from said AP, a response to said requested connection, said response acknowledging establishment of said connection between said STA and said AP, and said establishment of said connection being based on said indication pertaining to reservable resources.

### TECHNICAL FIELD

The present disclosure generally relates to a method for establishing a connection between a non-Access Point, AP, wireless station, STA, and an Access Point, AP, and, more specifically, establishing such a connection taking into account latency sensitive traffic of said non-AP STA.

### BACKGROUND

A handover is a procedure in telecommunications and mobile communications in which a connected session is transferred from one base station to another without disconnecting the session. Mobile services are based on mobility and handover, allowing the corresponding User Equipment to be moved from one cell site range to another or to be switched to the nearest cell site for better performance.

In Wi-Fi, such a handover procedure does not exist. Rather, if a non-AP station, STA, wants to move from one cell to another, it needs to basically shut down its connection to the current Access Point, AP, before setting up a new connection with a target AP. The decision to move from one AP to another AP is usually taken by the non-AP STA. Such a decision may be based on various aspects such as the throughput in the current AP and received signal strength indicators from neighbouring APs.

Some background information with respect to establishing a connection for a non-AP STA in Wi-Fi is provided below.

Whenever a non-AP STA initially discovers a network and wants to establish a connection, it is to perform a full connection establishment procedure with the AP to access the network. This action consists of a number of steps such as L2 authentication and association, EAP authentication, EAPOL, and DHCP. This activity generates many frames in both directions over the wireless link.

The Wi-Fi alliance program Optimized Connectivity introduces Fast Initial Link Setup, FILS, improvement based on the IETF's EAP re-authentication protocol, ERP. With FILS, the initial connection setup can be completed by transmitting just four frames on the wireless link.

ERP enables fast authentication by remembering at the client and the backend Authentication/Authorization/Accounting, AAA, server, the past/previous authentication state established at an earlier point in time. Remembering this state allows for quick client admission thereby eliminating the entire EAP authentication from the current connection setup. Notably, EAP authentication is usually the biggest contributor to connection setup latency.

Further, FILS introduces piggybacking of ERP and EAPOL messages on L2 authentication and association messages. It performs DHCP address acquisition in parallel with the L2 authentication and association steps.

Once the initial connection is established, subsequent roaming between APs is achieved using techniques that are already popular and available in today's Wi-Fi networks such as 802.11r Fast Transition.

The IEEE 802.11r amendment introduced the Fast BSS Transition, FT, mechanism. It defines a means for a non-AP STA to set up security and Quality-of-Service, QoS, parameters prior to reassociation to a new AP. This mechanism allows time-consuming operations to be removed from the time-critical reassociation process. During a handover across mobility domains, the overhead incurred during the FT initial mobility domain association in a robust security network, RSN, can be reduced using FILS authentication.

Fast BSS transition seeks to reduce the length of time that connectivity is lost between a non-AP STA and the DS during a BSS transition. The FT protocols are part of the reassociation service and only apply to STA transitions between APs within the same mobility domain within the same ESS.

The FT protocols require information to be exchanged during the initial association, or a later reassociation, between a STA and AP. The initial exchange is referred to as the FT initial mobility domain association. Subsequent reassociations to APs within the same mobility domain may make use of the FT protocols.

One of the problems related to the above described procedures for connecting a non-AP STA to an AP is related to latency sensitive traffic. There are no mechanisms in place that could timely inform the non-AP STA whether the target AP is able to support latency requirements of the traffic for the non-AP STA. Similarly, there are no mechanisms that could timely inform the target AP about the latency requirement of the traffic for the non-AP STA.

### SUMMARY

It is an object of the present disclosure to provide for a method of establishing a connection between a non-Access Point, AP, wireless station, STA, and an Access Point, AP. It is a further object of the present disclosure to provide for corresponding methods.

In a first aspect, there is provided a method of establishing a connection between a non-Access Point, AP, wireless station, STA, and an Access Point, AP, of a wireless Local Area Network, WLAN.

The method comprises the steps of:
providing, by said STA, to said AP, at least one parameter related to resource reservation at said AP for latency sensitive traffic;
receiving, by said STA, from said AP, an indication pertaining to reservable resources at said AP for said latency sensitive traffic;
requesting, by said STA, to said AP, said connection between said STA and said AP;
receiving, by said STA, from said AP, a response to said requested connection, said response acknowledging establishment of said connection between said STA and said AP, and said establishment of said connection being based on said indication pertaining to reservable resources.

It may be beneficial if the STA and the AP exchange information with respect to resource reservation at the AP for latency sensitive traffic before, or during, the connection setup to that particular AP.

For example, the STA may provide at least one parameter related to resource reservation at the AP for latency sensitive traffic. Such a parameter may form a requirement for the STA to ensure that its traffic is able to meet latency requirements. The resource reservation may, for example, relate to available time/frequency/spatial stream resources.

The AP may provide an indication pertaining to reservable resources at the AP for the latency sensitive traffic. Such an indication may be an explicit indication provided in a message exchanged between the AP and the STA or may be implicit by, for example, not sending a rejection thereby implicitly acknowledging that the AP is able to provide support for the at least one parameter.

It is noted that the presented method is applicable to scenarios in which the STA initially requests a connection to the AP, but also to scenarios in which the STA is connected to a first AP and intends to move to another AP. In the latter, the STA may disconnect from the first STA and (re)-connect to the other AP. In both above described scenarios, the STA may have latency sensitive traffic and may decide to determine, upfront, or during connection establishment, whether the target AP is able to meet those latency requirements.

The step of requesting, by said STA, to said AP, said connection between said STA and said AP may comprise multiple sub-steps. For example, the STA may transmit an association request message for requesting association to the AP and may transmit an authentication request message for authenticating the AP. The association and authentication may be performed using two separate message or may be combined into a single message.

It is noted that, in the context of the present disclosure, the messages exchanged between the AP and the STA may traverse a proxy node. The proxy node is, for example, an AP to which the STA is currently connected. Another option for the proxy node is a ProSe device, i.e. a proximity device that allows STAs to communicate directly to on another and allows STAs to function as a proxy towards an AP for another STA, or anything alike that is able to forward messages to, and from, the STA.

In an example, the step of requesting said connection comprises any one or more of:
transmitting, by said STA, to said AP, an association request message for requesting association to said AP;
transmitting, by said STA, to said AP, an authentication request message for authenticating said STA,
wherein said at least one requested parameter related to resource reservation at said AP for latency sensitive traffic is provided in any one or more of said association request message and said authentication request message.

The inventors have found that it may not be necessary to use a standalone message for conveying the at least one parameter related to resource reservation at the AP for latency sensitive traffic. It may be beneficial to use messages that are already in place during the connection establishment for conveying such a parameter. Typically, an association request message as well as an authentication 5 request message may be used for this particular purpose.

In a further example, the step of receiving said indication pertaining to reservable resources at said AP for said latency sensitive traffic comprises:
receiving, by said STA, from said AP, an acknowledgement thereby acknowledging that said AP is able to fulfil the at least one requested parameter related to resource reservation at said AP for latency sensitive traffic.

The acknowledgement is, for example, sent using a dedicated message from the AP to the STA. The acknowledgement may, alternatively, be a specific field or flag in an existing message exchanged between the AP and the STA.

In a further example, the step of receiving said indication pertaining to reservable resources at said AP for said latency sensitive traffic comprises:
receiving, by said STA, from said AP, an alternative at least one parameter to said at least one requested parameter, wherein said AP is able to fulfil said alternative at least one parameter.

In case the AP is not able to fulfil the requested at least one parameter, the AP may decide to provide an alternative to the STA. It may then be up to the STA whether or not to accept such an alternative, i.e. whether the alternative is sufficient for the latency sensitive traffic of the STA. The alternative may be communicated using at least one (alternative) parameter as well.

In yet another example, the step of receiving said indication pertaining to reservable resources at said AP for said latency sensitive traffic is implicitly comprised by said step of receiving, by said STA, from said AP, said response to said requested connection.

As mentioned above, the AP does not need to explicitly signal that it is able to fulfil the requirements set by the STA with the requested at least one parameter. Such a confirmation may be made implicitly.

In a further example, the step of providing, by said STA, to said AP, said at least one requested parameter related to resource reservation at said AP for latency sensitive traffic comprises:
providing, by said STA, to said AP, said at least one requested parameter in a standalone initialization frame.

Since handovers, or re-associations, may be attractive for multi-AP coordination, this option would make sense if an improved handover protocol were to be introduced entirely. In such a case, it may be beneficial to use separate frame exchanges for this purpose. As such, a standalone initialization frame may be used for conveying the at least one requested parameter from the STA to the AP.

In a further example, the at least one requested parameter is any one or more of:
bandwidth setting,
Target Wake Time, TWT, parameter,
previous and current signal strength indicator,
Service Periods, SP, reference time,
Transmit configuration and capability, and
traffic characteristics.

The bandwidth setting is, for example, the previous bandwidth that the STA was operating in with a connection to a previous AP. The previous TWT parameters are discussed in more detail with respect to the figures. These TWT parameters may include periodicity, duration, low latency TIDs and reference SP times.

In a further detailed example, the at least one requested parameter is part of a restricted Target Wake Time, r-TWT, procedure of an 802.11 based WLAN.

In a second aspect of the present disclosure, there is provided a method of establishing a connection between a non-Access Point wireless station, STA, and an Access Point, AP, of a wireless Local Area Network, WLAN, wherein said method comprises the steps of:
receiving, by said AP, from said STA, at least one requested parameter related to resource reservation at said AP for latency sensitive traffic;
providing, by said AP, to said STA, an indication pertaining to reservable resources at said AP for said latency sensitive traffic;
receiving, by said AP, from said STA, a request for said connection between said STA and said AP;
transmitting, by said AP, to said STA, a response to said requested connection and thereby acknowledging an established connection between said STA and said AP and based on said indication pertaining to reservable resource.

It is noted that the advantages as explained with respect to the first aspect of the disclosure, being the method of establishing a connection between the STA and the AP, also apply, mutatis mutandis, to the second aspect of the present disclosure.

In an example, the step of receiving said request for said connection comprises any of:
receiving, by said AP, from said AP, an association request message for requesting association to said AP;
receiving, by said AP, from said AP, an authentication request message for authenticating said STA,
wherein said at least one requested parameter related to resource reservation at said AP for latency sensitive traffic is provided in any of said association request message and said authentication request message.

In a further example, the step of providing said indication pertaining to reservable resources at said AP for said latency sensitive traffic comprises:
transmitting, by said AP, to said STA, an acknowledgement thereby acknowledging that said AP is able to fulfil the at least one requested parameter related to resource reservation at said AP for latency sensitive traffic.

In another example, the step of providing said indication pertaining to reservable resources at said AP for said latency sensitive traffic comprises:
transmitting, by said AP, to said STA, an alternative at least one parameter to said at least one requested parameter, wherein said AP is able to fulfil said alternative at least one parameter.

In yet another example, the step of providing said indication pertaining to reservable resources at said AP for said latency sensitive traffic is implicitly comprised by said step of transmitting said response to said requested connection.

In an example, the step of receiving, by said AP, from said STA, said at least one requested parameter related to resource reservation at said AP for latency sensitive traffic comprises:
receiving, by said AP, from said STA, said at least one requested parameter in a standalone initialization frame.

In a further example, the at least one requested parameter is any of:
bandwidth setting,
Target Wake Time, TWT, parameter,
previous and current signal strength indicator,
Service Periods, SP, reference time,
Transmit configuration and capability, and traffic characteristics.

In an example, the at least one requested parameter is part of a restricted Target Wake Time, r-TWT, procedure of an 802.11 based WLAN.

In yet another example, the method comprises the step of:
establishing, by said AP, said r-TWT based on said indication pertaining to reservable resources at said AP for said latency sensitive traffic.

In a third aspect of the present disclosure, there is provided a computer program product comprising a computer readable medium having instructions stored therein which, when executed by a Station of a Wireless Local Area Network, WLAN, cause said station to implement a method in accordance with any of the examples.

It is noted that the advantages as explained with respect to the first aspect of the disclosure, being the method of establishing a connection between the STA and the AP, also apply, mutatis mutandis, to the third aspect of the present disclosure.

In a fourth aspect, there is provided a non-Access Point, Non-AP, wireless station, STA, arranged to support establishing of a connection between said STA and an Access Point, AP in a Wireless Local Area Network, WLAN, wherein said non-AP wireless STA comprises a processor and a memory, said memory containing instructions executable by said processor whereby said non-AP wireless STA is operative for:
providing, to said AP, at least one requested parameter related to resource reservation at said AP for latency sensitive traffic;
receiving, from said AP, an indication pertaining to reservable resources at said AP for said latency sensitive traffic;
requesting, to said AP, said connection between said STA and said AP;
receiving, from said AP, a response to said requested connection and thereby acknowledging an established connection between said STA and said AP and based on said indication pertaining to reservable resource.

The above non-AP STA may be arranged to support establishing of a connection between said STA and an Access Point, AP in a Wireless Local Area Network, WLAN, wherein said non-AP wireless station comprises a processor and a memory, said memory containing instructions executable by said processor whereby said non-AP wireless STA is operative for performing a method in accordance with any of the examples as provided above.

In another aspect of the present disclosure, there is provided an Access Point, AP, arranged to support establishing of a connection between a non-Access Point, AP, wireless station, STA, and said AP in a Wireless Local Area Network, WLAN, wherein said AP comprises a processor and a memory, said memory containing instructions executable by said processor whereby said AP is operative for:
receiving, from said STA, at least one requested parameter related to resource reservation at said AP for latency sensitive traffic;
providing, to said STA, an indication pertaining to reservable resources at said AP for said latency sensitive traffic;
receiving, from said STA, a request for said connection between said STA and said AP;
transmitting, to said STA, a response to said requested connection and thereby acknowledging an established connection between said STA and said AP and based on said indication pertaining to reservable resource.

The AP may be arranged to support establishing of a connection between a non-Access Point, AP, wireless station, STA, and said AP in a Wireless Local Area Network, WLAN, wherein said AP comprises a processor and a memory, said memory containing instructions executable by said processor whereby said AP is operative for performing a method in accordance with any of the previous examples as provided above.

In addition to the above, there is provided there is provided a non-Access Point, AP, wireless station, STA, arranged to support establishing of a connection between said STA and an Access Point, AP in a Wireless Local Area Network, WLAN, wherein said STA comprises:
a processor module for providing, to said AP, at least one requested parameter related to resource reservation at said AP for latency sensitive traffic;
a receiver module for receiving, from said AP, an indication pertaining to reservable resources at said AP for said latency sensitive traffic;
a requesting module for requesting, to said AP, said connection between said STA and said AP;
wherein the receiver module is further for receiving, from said AP, a response to said requested connection and thereby acknowledging an established connection between said STA and said AP and based on said indication pertaining to reservable resource

In addition to the above, there is provided an Access Point, AP, arranged to support establishing of a connection between a non-Access Point, AP, wireless station, STA, and said AP in a Wireless Local Area Network, WLAN, wherein said AP comprises:
a receiving module for receiving, from said STA, at least one requested parameter related to resource reservation at said AP for latency sensitive traffic;
a processor module for providing, to said STA, an indication pertaining to reservable resources at said AP for said latency sensitive traffic;
wherein the receiving module is further for receiving, from said STA, a request for said connection between said STA and said AP; and the AP comprises:
a transmitter module for transmitting, to said STA, a response to said requested connection and thereby acknowledging an established connection between said STA and said AP and based on said indication pertaining to reservable resource

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The above and other aspects of the disclosure will be apparent from and elucidated with reference to the examples described hereinafter.

### BRIEF DESCRIPTION OF THE FIGURES

FIG. 1 discloses the Fast Transition, FT, protocol when performed over-the-air;

FIG. 2 discloses the FT protocol when performed over-the-DS;

FIG. 3 discloses an example of broadcast Target Wake Time, TWT, operation;

FIG. 4a discloses an example of broadcast TWT parameter set field format;

FIG. 4b discloses an example of a request type field format in broadcast TWT parameter set field;

FIG. 4c disclose an example of a broadcast TWT info subfield format;

FIG. 4d discloses an example of restricted TWT traffic info field format;

FIG. 5a discloses an example of a method in accordance with the present disclosure;

FIG. 5b discloses a further example of a method in accordance with the present disclosure;

FIG. 5c discloses another example of a method in accordance with the present disclosure;

FIG. 5d discloses yet another example of a method in accordance with the present disclosure;

FIG. 5e discloses another example of a method in accordance with the present disclosure;

FIG. 5f discloses yet another example of a method in accordance with the present disclosure;

FIG. 5g discloses an example of a method in accordance with the present disclosure;

FIG. 6 discloses an example of the method steps in accordance with the present disclosure;

FIG. 7 discloses a further example of the method steps in accordance with the present disclosure;

FIG. 8 discloses an example of a non-Access Point, AP, station, STA in accordance with the present disclosure;

FIG. 9 discloses an example of an Access Point, AP, in accordance with the present disclosure.

### DETAILED DESCRIPTION

It is noted that in the description of the figures, same reference numerals refer to the same or similar components performing a same or essentially similar function.

A more detailed description is made with reference to particular examples, some of which are illustrated in the appended drawings, such that the features of the present disclosure may be understood in more detail. It is noted that the drawings only illustrate typical examples and are therefore not to be considered to limit the scope of the subject matter of the claims. The drawings are incorporated for facilitating an understanding of the disclosure and are thus not necessarily drawn to scale. Advantages of the subject matter as claimed will become apparent to those skilled in the art upon reading the description in conjunction with the accompanying drawings.

The ensuing description above provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment of the disclosure, it being understood that various changes may be made in the function and arrangement of elements, including combinations of features from different embodiments, without departing from the scope of the disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, electromagnetic, or a combination thereof. Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or” in reference to a list of two or more items, covers all of the following interpretations of the word: any of the items in the list, all of the items in the list, and any combination of the items in the list.

These and other changes can be made to the technology in light of the following detailed description. While the description describes certain examples of the technology, and describes the best mode contemplated, no matter how detailed the description appears, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

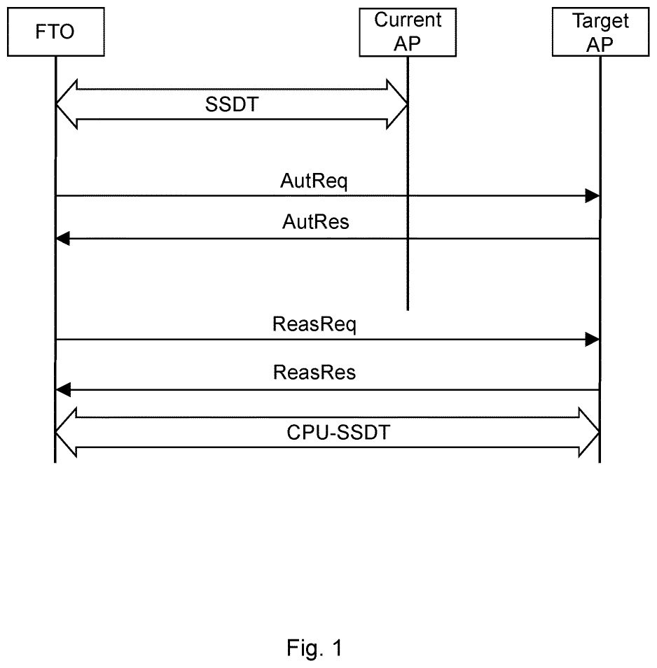

FIG. 1 discloses the Fast Transition, FT, protocol when performed over-the-air.

As mentioned above, the Fast Transition, FT, protocols may require information to be exchanged during the initial association, or a re-association, between a STA and an AP. The initial exchange is referred to as the FT initial mobility domain association. Subsequence reassociations to Aps within the same mobility domain may make use of the FT protocols.

Two FT protocols are currently defined. The so-called FT protocol is executed when a STA makes a transition to a target AP and does not require a resource request prior to its transition. The so-called FT resource request protocol is executed when an FTO requires a resource request prior to its transition.

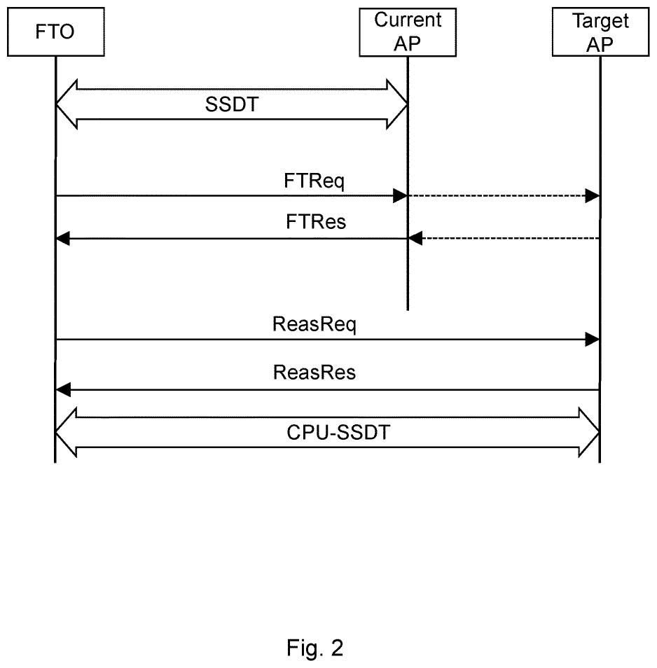

For a STA to move from its current AP to a target AP utilizing the FT protocols, the message exchanges are performed using one of two methods. The first method is shown in FIG. 1, the second method is shown in FIG. 2.

FIG. 1 is directed to over-the-air situation. The STA, referred to as FT Originator, i.e. FTO in FIG. 1, communicates directly with the target AP using authentication with the FT authentication algorithm.

In the example shown in FIG. 1, the STA has established a successful secure session & data transmission, SSDT, with the current AP and intends to move, i.e. re-associate or be handed over, to a target AP.

In this case, the authentication request, AutReq, the authentication response, AuthRes, the Reassociation request, ReasReq, and the Reassociation response, ReasRes, are all directly exchanged between the target AP and the STA. The current AP does not function as a proxy or anything alike. Based on the messages exchanged between the STA and the target AP, a successful secure session & data transmission, SSDT, may be established between the STA and the target AP.

FIG. 2 is directed to the over-the-DS situation. This situation is similar to the one described in relation with FIG. 1, albeit that here at least the FT request and the FT response are being proxied by the current AP. The current AP thus functions as a middleman for these message between the STA and the target AP.

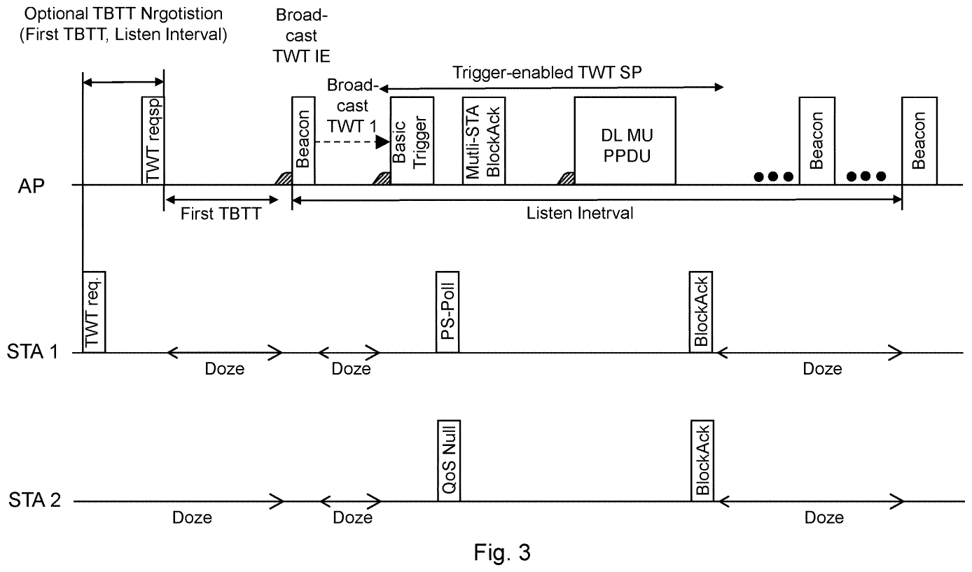

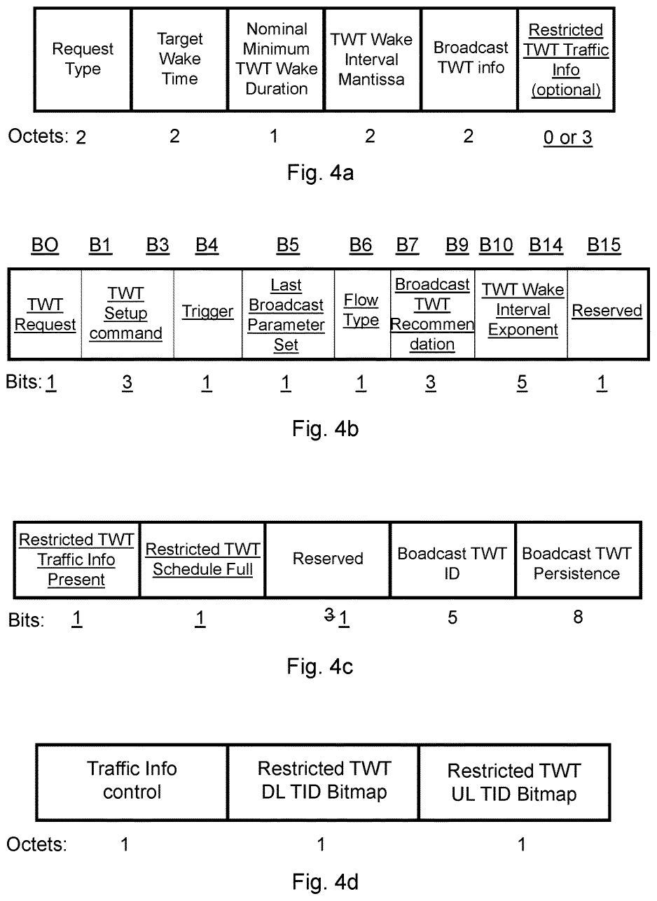

FIGS. 3, 4a and 4b are all related to the feature Target Wake Time, TWT.

In 802.11ax, one of the introduced features is Target Wake Time, TWT, which allows an AP to schedule activity in the Basic Service Set, BSS. Initially, TWT was designed and introduced to reduce the required amount of time that a STA utilizing a power management mode needs to be awake.

A TWT agreement allows STAs to allocate and operate at non-overlapping times, and therefore bundles the frame exchanges in predefined service periods, SPs. However, the bundling also serves the purpose to reduce contention between STAs, as the number of simultaneous active STAs is lowered by separating them into different SPs of different TWT agreements.

TWT SPs may be set up in two different ways, either by performing individual TWT agreements or by the AP announcing in its beacon frame, called broadcast TWT agreement. Broadcast TWT agreements indicate when an SP is scheduled, and which member STAs should be prepared to participate. These are, however, agreements and even though an AP can force a TWT capable STA to either join a broadcast TWT schedule or setup an individual agreement, the STA is allowed to immediately teardown the agreement. To support these negotiations, there are several options that can be signalled between devices to reach an agreement that both sides are satisfied with.

Furthermore, an SP may be terminated by an AP if it is no longer required for delivering the member data. This could either be due to overprovisioning (from not knowing the correct MCS for example) or that the data that was to be delivered never arrived, etc.

It is noted that the TWT mechanism may guarantee that STAs will be awake at the agreed time, but it does not prevent STAs to be awake and contend for channel access at any other point in time. To avoid this, the AP may need to set up the MU EDCA parameters in the STAs by selecting access parameters that effectively prevent the STAs from contending.

By doing so, the AP may create a controlled environment in its BSS, i.e. Uplink, UL, transmissions may be triggered with TFs, if no legacy STAs are present.

Restricted TWT, r-TWT, has been introduced, which builds upon the same principle of scheduling STAs with increased protection of the SPs. However, it also allows an AP to prioritize certain latency sensitive traffic flows.

The inventors have found that it may be beneficial to negotiate, or set up, such a restricted TWT during the mobility procedure, for example during re-association of association of a STA with an AP, as an agreed r-TWT between the STA and AP aids in supporting latency sensitive traffic from the STA. The r-TWT is thus not set up after (re)-association of the STA with the target AP, but during the actual connection phase. This ensure that the STA is aware, upfront, whether its latency sensitive traffic is supported. The STA may even base its decision to perform a re-association based on whether the target STA is able to meet requirements laid down in the r-TWT information that is exchanged between the STA and the target AP.

For example, to protect the SP from other devices trying to access the medium,

1. A scheduling AP may signal a quiet interval with the same start time as the SP with a duration of 1 time unit (1 TU=1024 μs).
2. r-TWT capable non-AP STAs shall ensure that their ongoing TxOP ends before any upcoming SP advertised by the associated AP. Similarly, if they are not a member of an upcoming SP, they cannot start new data transmissions that will not finish before the SP starts as well.

The service period may thus serve, or be allocated, to STAs that have latency sensitive traffic.

FIG. 3 discloses an example of broadcast Target Wake Time, TWT, operation.

The 802.11be specification, for example, allows r-TWT broadcast agreements for setting up SPs. These agreements set up periodic SPs.

Note in FIG. 3 the TWT request frame and the TWT response frame. These frames are used to negotiate the TWT specifics. The TWT request frame (i.e., the TWT Setup Command field in an initiating frame), looks like the one shown in FIG. 4a, where the Request Type field, i.e. FIG. 4b, indicates whether the frame is a TWT request or TWT response.

FIG. 4a discloses an example of broadcast TWT parameter set field format and FIG. 4b discloses an example of a request type field format in broadcast TWT parameter set field.

For example, if the TWT Request bit is “0”, the frame may be a TWT response frame, otherwise it may be a TWT request frame. Note that the TWT request and TWT response are frames sent, in the prior art, already when a STA is associated with an AP.

The inventors have found that it thus may be beneficial to signal, or exchange, r-TWT information during connection setup, for example during re-association or association of a STA with a target AP.

FIG. 4c discloses an example of a broadcast TWT info subfield format and FIG. 4d discloses an example of restricted TWT traffic info field format.

The broadcast TWT info subfield, i.e. FIG. 4c, may comprise information on the ID of the TWT agreement as well as for how long, for example in terms of beacon intervals, this agreement should persist for. Furthermore, it indicates if there is r-TWT traffic info present in the broadcast TWT parameter set as well as if the broadcast schedule is full and that there is no point in a TWT requesting STA to request to join.

The restricted TWT traffic info field, i.e. FIG. 4d, is optionally contained in the broadcast TWT parameter set. It contains a traffic info control field, which indicates if the following DL and UL bitmaps are valid. The bitmaps then indicate for each TID which of them that are considered latency critical by the low latency traffic differentiator.

The inventors have found that, for a latency critical device that uses or relies on the restricted-TWT to deliver its latency sensitive traffic, transitioning from one BSS to another may result in failure of service. This is due to the fact that such STAs do not have any means to setup, or negotiate, the restricted TWT before the STA has been fully connected to the target AP.

This problem is addressed in the present disclosure, in that a method is proposed for a latency sensitive STA that uses the r-TWT mechanic to negotiate and potentially setup a new r-TWT at an AP in combination with establishing a new connection during mobility. The restricted TWT is thus tackled before the connection to the target AP is actually established. This allow seamless transfer of the r-TWT scheme from one AP to the other.

The general concept of the present disclosure is to multiplex, or combine, r-TWT parameters, i.e. at least one parameter related to resource reservation at the AP for latency sensitive traffic, with a mobility procedure like initial connection establishment or re-association. This may either be through direct communication between a current and target AP, or a roaming STA requesting handover.

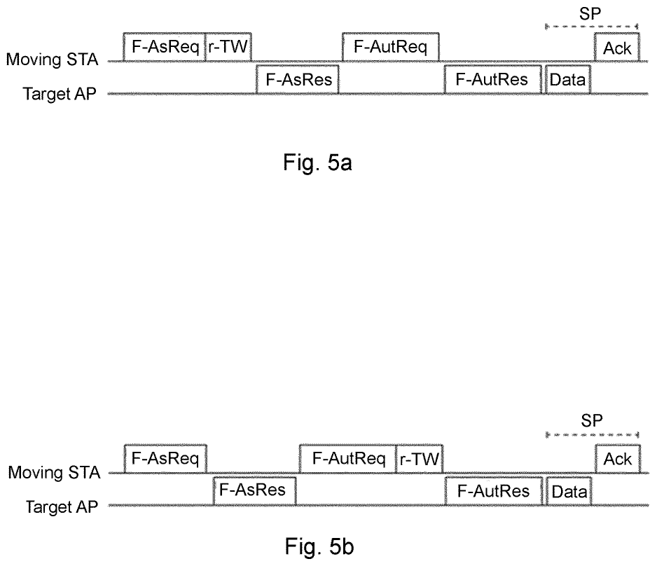

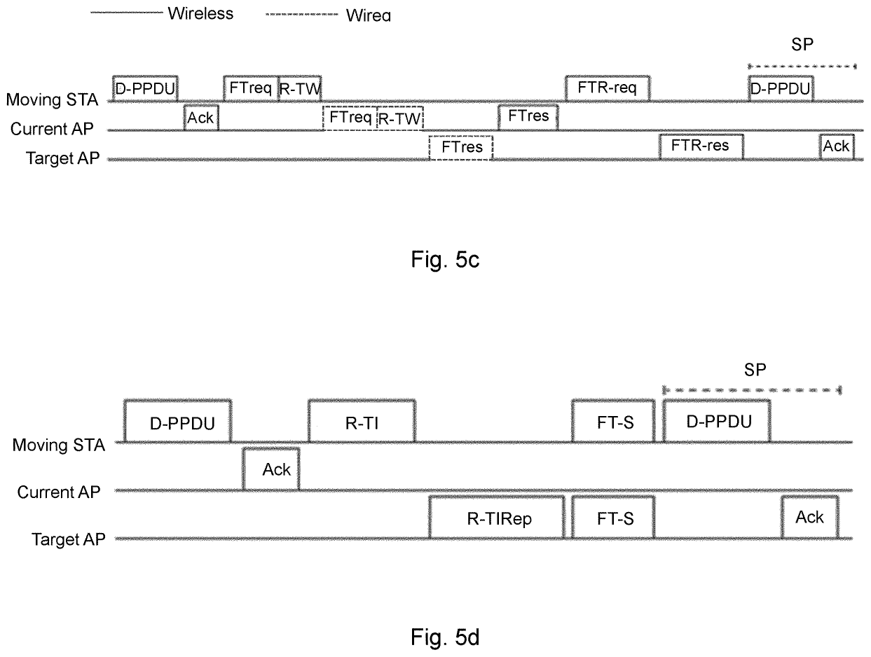

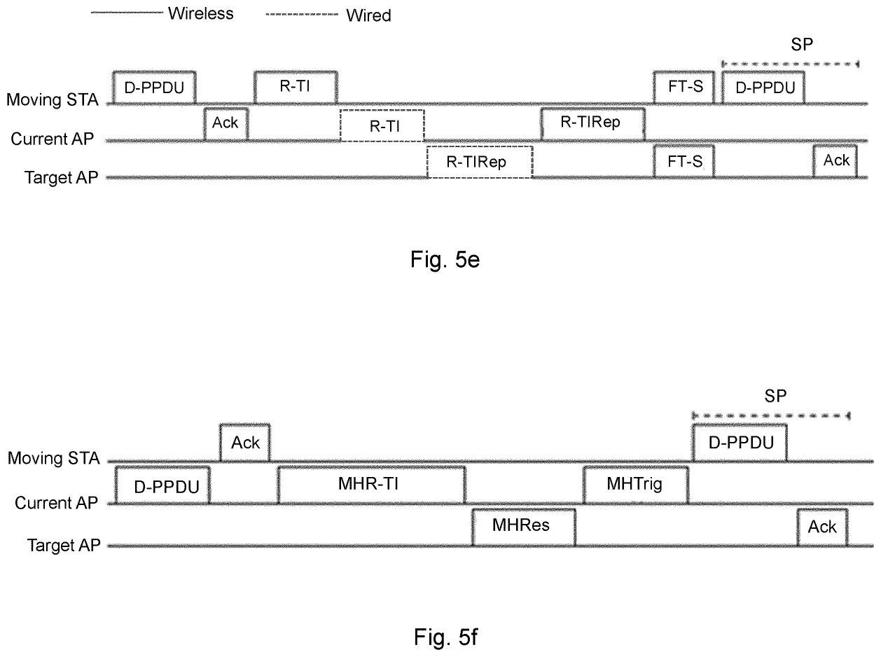

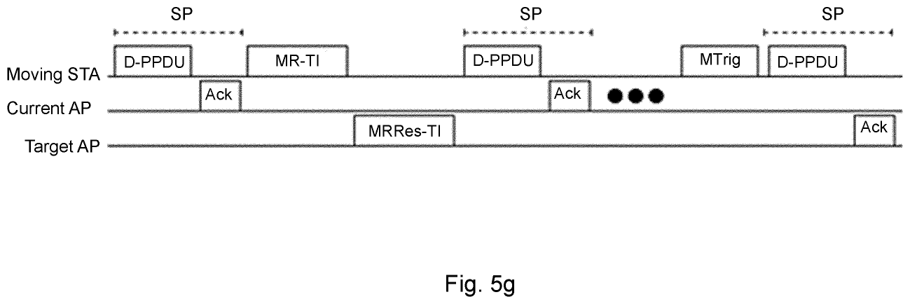

Traditionally in Wi-Fi, the STA has been in control of the mobility decision. Therefore, in the examples of FIGS. 5a-5g, the STA is the initiator of the transition. However, the present disclosure is also applicable in case the AP is the initiator.

Finally in a multi-AP coordinating scenario, the handover, or re-association, initiator may be a current AP to which a STA is associated, and the responder may be the AP to which the STA is transitioning to.

There are multiple ways to include r-TWT information, for example a wrapper element: Adding an extra field with r-TWT information in the current mobility procedure, and a stand-alone signalling: Since handover may be attractive for multi-AP coordination this option would make sense if a new handover protocol were to be introduced entirely. In this case r-TWT information is included in separate frame exchanges.

In accordance with the present disclosure, at least one parameter related to reservable resources at the AP for latency sensitive traffic is exchanged between the STA and the AP. In the context of the FIGS. 5a-5g this is referred to as r-TWT information. It is noted that the present disclosure is not limited to exchanging the full r-TWT information as at least one information related to the r-TWT information would suffice.

As mentioned in the introduction, a STA typically uses Received Signal Strength Indicator, RSSI, to select which AP to associate with. In enterprise use cases, there may be many APs providing good enough RSSI for the current application. In that case, a more relevant indication may be the occupancy at the APs, particularly the availability of SPs using r-TWT.

A concept of the r-TWT SP availability may be obtained from the beacon of the APs. If the AP cannot serve the STA with the required resources, the STA may defer from association, and possibly attempt association with some other AP. However, even if the AP appears to have r-TWT SP availability, it may be unable to serve the STA because of other reasons, for example due to traffic load, or scheduled individual TWT allocations.

To accommodate the above, in an example, it is proposed to introduce two new fields, the r-TWT initialization field and the r-TWT initialization reply field. These fields field may be piggybacked in other frames, which are indicated with a “r-TWT wrapper frame”. If the r-TWT initialization/initialization-reply fields are standalone hey are referred to as r-TWT initialization frames and r-TWT initialization reply frames, respectively. The r-TWT initialization frame is optional and provided it is sent, the r-TWT initialization reply frame is also optional. The TWT request and TWT response frames may be used as baseline to create the r-TWT initialization and r-TWT initialization reply frames.

The r-TWT reply and r-TWT response may act as a baseline to create the r-TWT initialization and r-TWT initialization reply frames. In order to properly estimate the parameters of the new r-TWT SP at the target AP, some information may be signalled during connection establishment, for example: Previous Bandwidth, Previous r-TWT parameters, Periodicity, Duration, Low latency TIDs, Reference SP time, Previous and current RSSI, Traffic characteristics, STA configuration and capabilities, e.g., number of antennas.

With this information, the target AP may directly set up a r-TWT agreement that it believes will be sufficient for the roaming STA and its application. Note that the concept of the present disclosure is, amongst other, that this setup would enable a completely transparent transition of the r-TWT from one AP to the other.

If the AP cannot fulfil the requirements for the STA, the AP may respond with a r-TWT initialization reply field indicating it cannot fulfil the requirements. Optionally, the r-TWT initialization reply may include a new proposal for r-TWT parameters, at which point the STA decides whether it want to continue with the association, or not.

As such the reply from the AP may contain information in addition to the r-TWT reply, such as an alternate r-TWT parameter set, alternate timing parameters, alternate Tx configuration, reason for denial, e.g., may be because of insufficient resources, congested TWT schedule, weak link budget etc.

In FIG. 5a, an example of the present disclosure is shown when the STA is initiating an initial connection with a network using the FILS procedure. Here, the r-TWT information wrapper is attached to the initial association message in order to give the target AP as much time as possible to take this into account before setting up the SP. Then after the STA is associated it receives data in its SP.

FIG. 5b is similar to FIG. 5a, but here the r-TWT related information is shared in the second message along with the authentication request when the association has already been made. This may be beneficial as to not waste resources on an association that cannot be made.

In another example as shown in FIG. 5c, the present disclosure is used for a moving STA that has already made an initial connection to the network and now wants to move throughout the network. Thus, it uses the FT protocol to make that transition. Here, the protocol is performed over-the-air and thus the moving STA attaches the r-TWT related information to the authentication, or reassociation, request to inform of the needs of a r-TWT schedule. Furthermore, in yet another example, the target AP may negotiate, or inform, the moving STA that its request for r-TWT resources may not be accepted, but that some other agreement may be arranged through some additional information in the response frames.

FIG. 5d shows a similar example as in FIG. 5c, but here the FT protocol is instead performed over-the-DS. Thus, the TWT related information is relayed from the current AP to the target AP through a wired, or wireless, backbone.

Furthermore, in another example as shown in FIG. 5e, the moving STA may ask a target AP if a r-TWT schedule can be supported before taking the decision to transition. This may either be performed over-the-air or over-the-DS. In these figures the FT setup has been compressed as to not take up too much space.

Moreover, in an example of the present disclosure, the method is applied to a multi-AP handover concept, as can be seen in FIG. 5f. Here the handover decisions and information sharing take place between the coordinating APs. Thus, we can see that the current AP initiates the handover by sending a request to the target AP as well as any relevant TWT related information. The target AP then responds if it may accept this handover or not, followed by a trigger from the current AP to inform the STA that it is now associated to the target AP.

FIG. 5g discloses a scenario where a make-before-break, MBB, mobility scheme is applied. Thus, the STA may have multiple active connections with more than just its current AP in order to do a fast switch whenever some condition of the STA has reached a limit and a transition is deemed necessary. In this case, the r-TWT related information is already shared and negotiated upon when the auxiliary connection is established. However, the new SP agreement does not take effect until the trigger to do a full transition is sent. In some cases, it may be beneficial for the target AP to set up the agreement in advance and potentially also add its other associated STAs to the agreement, e.g., if it does not currently have an r-TWT schedule established.

Throughout examples provided above, r-TWT is discussed as that is considered a novel mechanism for low latency applications. However, there is nothing here that would prevent this procedure to also setup a new TWT agreement, this is also considered to be related to latency sensitive traffic.

In the examples above, the r-TWT wrapper signalling has been used to directly setup the new r-TWT SP at the target AP, omitting the beacon signalling used in prior art. In some embodiments of the present disclosure, the beacon is to be sent in order to update the r-TWT schedule and in others the r-TWT schedule is updated directly.

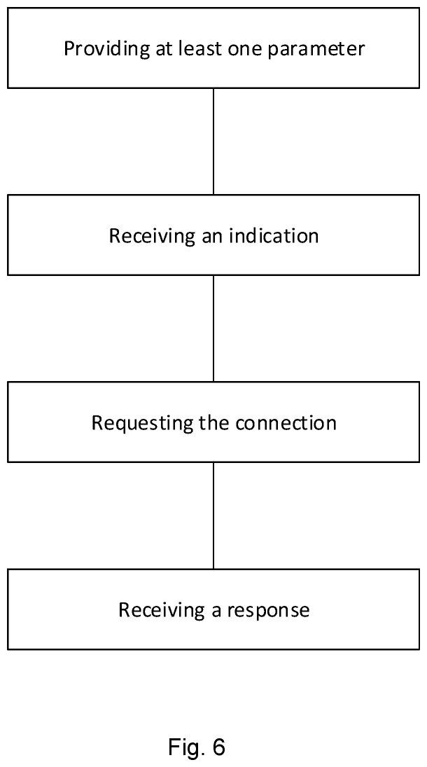

FIG. 6 discloses an example of the method steps in accordance with the present disclosure.

The method steps comprise providing, by said STA, to said AP, at least one parameter related to resource reservation at said AP for latency sensitive traffic, receiving, by said STA, from said AP, an indication pertaining to reservable resources at said AP for said latency sensitive traffic, requesting, by said STA, to said AP, said connection between said STA and said AP, receiving, by said STA, from said AP, a response to said requested connection, said response acknowledging establishment of said connection between said STA and said AP, and said establishment of said connection being based on said indication pertaining to reservable resources.

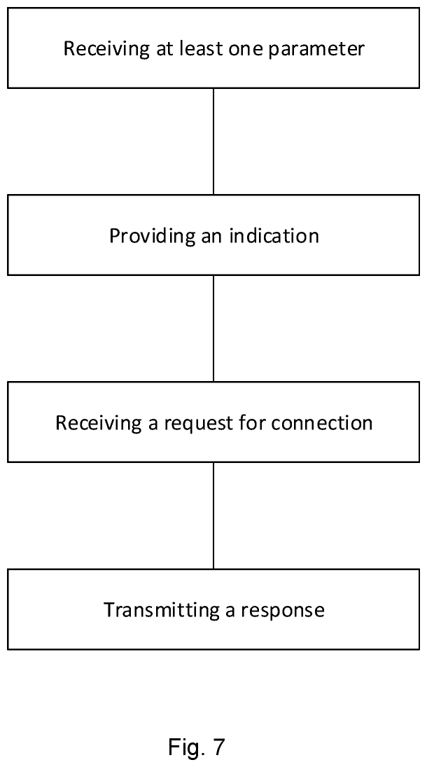

FIG. 7 discloses a further example of the method steps in accordance with the present disclosure.

The method steps comprise receiving, by said AP, from said STA, at least one requested parameter related to resource reservation at said AP for latency sensitive traffic, providing, by said AP, to said STA, an indication pertaining to reservable resources at said AP for said latency sensitive traffic, receiving, by said AP, from said STA, a request for said connection between said STA and said AP, transmitting, by said AP, to said STA, a response to said requested connection and thereby acknowledging an established connection between said STA and said AP and based on said indication pertaining to reservable resource.

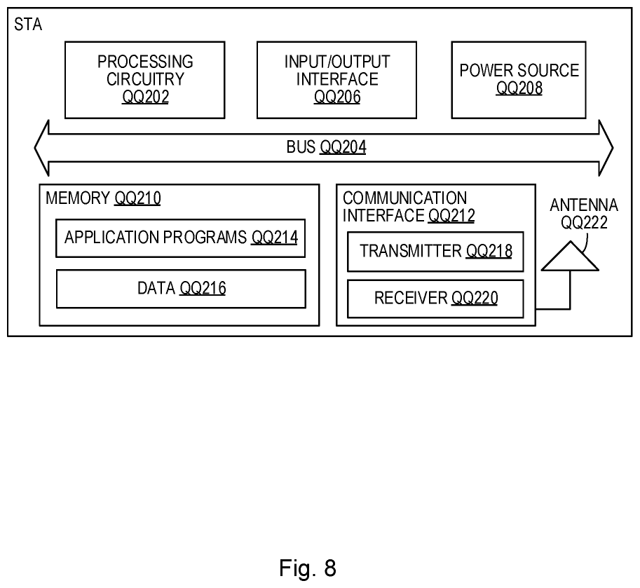

FIG. 8 discloses an example of a non-Access Point, AP, station, STA in accordance with the present disclosure.

The non-Access Point, AP, wireless station, STA, is arranged to support establishing of a connection between said STA and an Access Point, AP in a Wireless Local Area Network, WLAN, wherein said non-AP wireless station comprises a processor QQ202 and a memory QQ210, said memory QQ210 containing instructions, for example as indicated with QQ214 and QQ 216, executable by said processor.

The STA further comprises a communication interface QQ212 comprising a transmitter QQ218 and a receiver QQ220, wherein the communication interface QQ212 is connected to an antenna QQ222.

The STA further comprises a power source QQ208, an input/output interface QQ206, and a bus QQ204 connecting the different features of the STA to one another.

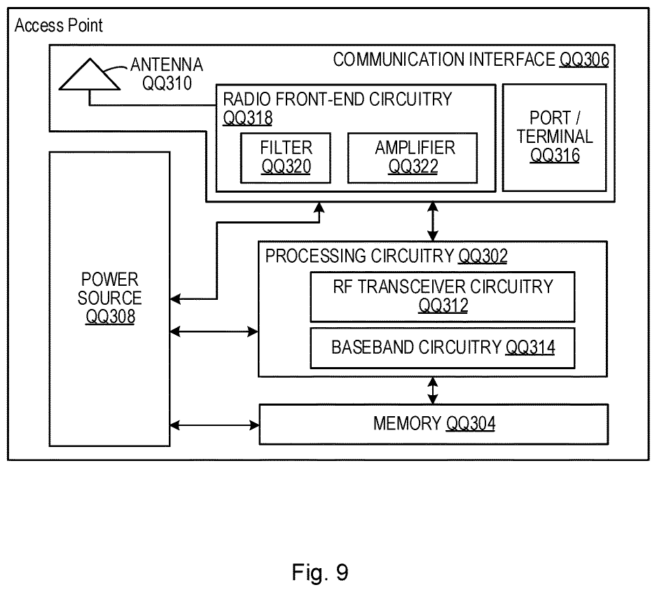

FIG. 9 discloses an example of an Access Point, AP, in accordance with the present disclosure.

The Access Point, AP, is arranged to support establishing of a connection between a non-Access Point, AP, wireless station, STA, and said AP in a Wireless Local Area Network, WLAN, wherein said AP comprises a processor QQ302 and a memory QQ304, said memory QQ304 containing instructions executable by said processor QQ302.

The processor QQ302 may further comprise a transceiver QQ312 and baseband circuitry QQ314. The communication interface QQ306 may comprise an antenna QQ310 connected to a radio front-end circuitry QQ318 having a filter QQ320 and an amplifier QQ322, and further comprises a terminal QQ316.

All the above features may be connected to a power source QQ308 for powering the AP.

To reduce the number of claims, certain aspects of the technology are presented below in certain claim forms, but the applicant contemplates the various aspects of the technology in any number of claim forms. For example, while some aspect of the technology may be recited as a computer-readable medium claim, other aspects may likewise be embodied as a computer-readable medium claim, or in other forms, such as being embodied in a means-plus-function claim.

In the description above, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope thereof

### LIST OF REFERENCE NUMERALS USED

SSDT=Successful (Secure) Session & Data Transmission
AutReq=802.11 Authentication-Request (FTAA, RSNE[PMKR0Name], MDE, FTE[SNonce, R0KH-ID])
AutRes=802.11 Authentication-Response (FTAA, RSNE[PMKR0Name], MDE, FTE[ANonce, SNonce, R1KH-ID, R0KH-ID])
ReasReq=Reassociation Request (RSNE[PMKR1Name], MDE, FTE[MIC, ANonce, SNonce, =R1KH-ID, RoKH-ID], RIC-Request, RSNXE)
reasRes=Reassociation Response (RSNE[PMKR1Name], MDE, FTE[MIC, ANonce, SNonce, R1KH-ID, RoKH-ID, GTK[N]], IGTK[M], BIGTK[Q] RIC-Response, RSNXE) CPU-SSDT 802.1X Controlled Port Unblocked, Successful (Secure) Session & Data Transmission
FTReq=FT Request (FTO, TargetAP, RSNE[PMKR0Name, MDE, FTE[SNonce, R0KH-ID])
FTRes=FT Response (FTO, TargetAP, RSNE[PMKR0Name, MDE, FTE[ANonce, SNonce, R1KH-ID, R0KH-ID])
F-AsReq=FILS Association Request
F-AsRes=FILS Association Response
F-AutReq=FILS Authentication Request
F-AutRes=FILS Authentication Response
r-TW=r-TWT Wrapper
r-TI=r-TWT Initialization
r-TIRep=r-TWT Initialization Reply
D-PPDU=Data PPDU
FTR-Req=FT Reassociation Request
FTR-Res=FT Reassociation Response
FT-S=FT Setup
MHR-TI=MAP Handover Request+TWT Information
MHRes=MAP Handover Response
MHTrig=MAP Handover Trigger
MR-TI=MBB Request+TWT Information
MRRes-TI=MBB Response+TWT Information
MTrig=MBB Trigger

1-20. (canceled)

21. A method of establishing a connection between a non-Access Point (AP) wireless station (STA) and an Access Point (AP) of a wireless Local Area Network (WLAN), the method comprising:
providing, by said STA, to said AP, at least one parameter related to resource reservation at said AP for latency sensitive traffic;
receiving, by said STA, from said AP, an indication pertaining to reservable resources at said AP for said latency sensitive traffic;
requesting, by said STA, to said AP, said connection between said STA and said AP; and
receiving, by said STA, from said AP, a response to said requested connection, said response acknowledging establishment of said connection between said STA and said AP, and said establishment of said connection being based on said indication pertaining to reservable resources.

22. The method according to claim 21, wherein the step of requesting said connection comprises any one or more of:
transmitting, by said STA, to said AP, an association request message for requesting association to said AP; or
transmitting, by said STA, to said AP, an authentication request message for authenticating said STA;
wherein said at least one requested parameter related to resource reservation at said AP for latency sensitive traffic is provided in any one or more of said association request message and said authentication request message.

23. The method according to claim 22, wherein said step of receiving said indication pertaining to reservable resources at said AP for said latency sensitive traffic comprises:
receiving, by said STA, from said AP, an alternative at least one parameter to said at least one requested parameter, wherein said AP is able to fulfil said alternative at least one parameter.

24. The method according to claim 22, wherein said step of receiving said indication pertaining to reservable resources at said AP for said latency sensitive traffic is implicitly comprised by said step of receiving, by said STA, from said AP, said response to said requested connection.

25. The method according to claim 21, wherein said step of receiving said indication pertaining to reservable resources at said AP for said latency sensitive traffic comprises:
receiving, by said STA, from said AP, an acknowledgement thereby acknowledging that said AP is able to fulfil the at least one requested parameter related to resource reservation at said AP for latency sensitive traffic.

26. The method according to claim 21, wherein said step of providing, by said STA, to said AP, said at least one requested parameter related to resource reservation at said AP for latency sensitive traffic comprises:
providing, by said STA, to said AP, said at least one requested parameter in a standalone initialization frame.

27. The method according to claim 21, wherein said at least one requested parameter is any one or more of:
a bandwidth setting,
a Target Wake Time (TWT) parameter,
a previous and current signal strength indicator,
a Service Periods (SP) reference time,
a Transmit configuration and capability, or
traffic characteristics.

28. The method according to claim 21, wherein said at least one requested parameter is part of a restricted Target Wake Time (r-TWT) procedure of an 802.11 based WLAN.

29. A method of establishing a connection between a non-Access Point wireless station (STA) and an Access Point (AP) of a wireless Local Area Network (WLAN), the method comprising:
receiving, by said AP, from said STA, at least one requested parameter related to resource reservation at said AP for latency sensitive traffic;
providing, by said AP, to said STA, an indication pertaining to reservable resources at said AP for said latency sensitive traffic;
receiving, by said AP, from said STA, a request for said connection between said STA and said AP; and
transmitting, by said AP, to said STA, a response to said requested connection and thereby acknowledging an established connection between said STA and said AP and based on said indication pertaining to reservable resource.

30. The method according to claim 29, wherein the step of receiving said request for said connection comprises any of:
receiving, by said AP, from said AP, an association request message for requesting association to said AP; or
receiving, by said AP, from said AP, an authentication request message for authenticating said STA;
wherein said at least one requested parameter related to resource reservation at said AP for latency sensitive traffic is provided in any of said association request message and said authentication request message.

31. The method according to claim 29, wherein said step of providing said indication pertaining to reservable resources at said AP for said latency sensitive traffic comprises:
transmitting, by said AP, to said STA, an acknowledgement thereby acknowledging that said AP is able to fulfil the at least one requested parameter related to resource reservation at said AP for latency sensitive traffic.

32. The method according to claim 29, wherein said step of providing said indication pertaining to reservable resources at said AP for said latency sensitive traffic comprises:
transmitting, by said AP, to said STA, an alternative at least one parameter to said at least one requested parameter, wherein said AP is able to fulfil said alternative at least one parameter.

33. The method according to claim 29, wherein said step of providing said indication pertaining to reservable resources at said AP for said latency sensitive traffic is implicitly comprised by said step of transmitting said response to said requested connection.

34. The method according to claim 29, wherein said step of receiving, by said AP, from said STA, said at least one requested parameter related to resource reservation at said AP for latency sensitive traffic comprises:
receiving, by said AP, from said STA, said at least one requested parameter in a standalone initialization frame.

35. The method according to claim 29, wherein said at least one requested parameter is any of:
a bandwidth setting,
a Target Wake Time (TWT) parameter,
a previous and current signal strength indicator,
a Service Periods (SP) reference time,
a Transmit configuration and capability, or
traffic characteristics.

36. The method according to claim 29, wherein said at least one requested parameter is part of a restricted Target Wake Time, r-TWT, procedure of an 802.11 based WLAN.

37. The method according to any of the claim 36, wherein said method comprises the step of:
establishing, by said AP, said r-TWT based on said indication pertaining to reservable resources at said AP for said latency sensitive traffic.

38. A non-Access Point (AP) wireless station (STA) configured to support establishing a connection between said STA and an Access Point (AP) in a Wireless Local Area Network (WLAN), wherein said non-AP wireless station comprises:
a memory containing instructions; and
a processor that, based on executing the instructions stored in the memory, controls the STA to:
provide, to said AP, at least one requested parameter related to resource reservation at said AP for latency sensitive traffic;
receive, from said AP, an indication pertaining to reservable resources at said AP for said latency sensitive traffic;
request, to said AP, said connection between said STA and said AP; and
receive, from said AP, a response to said requested connection and thereby acknowledging an established connection between said STA and said AP and based on said indication pertaining to reservable resource.

39. An Access Point (AP) configured to support establishing a connection between a non-Access Point (AP) wireless station (STA) and said AP in a Wireless Local Area Network (WLAN), wherein said AP comprises:
a memory containing instructions; and
a processor that, based on executing the instructions contained in the memory, controls the AP to:
receive, from said STA, at least one requested parameter related to resource reservation at said AP for latency sensitive traffic;
provide, to said STA, an indication pertaining to reservable resources at said AP for said latency sensitive traffic;
receive, from said STA, a request for said connection between said STA and said AP;
transmit, to said STA, a response to said requested connection and thereby acknowledging an established connection between said STA and said AP and based on said indication pertaining to reservable resource.
